(19) United States
(12) Patent Application Publication
(10) Pub. No.: US 2018/0348909 A1
(43) Pub. Date: Dec. 6, 2018

(54) TOUCH PANEL

(71) Applicant: EGALAX_EMPIA TECHNOLOGY INC., Taipei City (TW)

(72) Inventor: CHINFU CHANG, Taipei City (TW)

(21) Appl. No.: 15/990,896

(22) Filed: May 29, 2018

Related U.S. Application Data
(60) Provisional application No. 62/512,206, filed on May 30, 2017.

(51) Int. Cl. G06F 3/044; G06F 3/047

(52) U.S. Cl. CPC G06F 3/044; G06F 2203/04104; G06F 3/047

(57) ABSTRACT

The present invention provides a touch panel including: multiple first electrodes being parallel to a first axis; multiple second electrodes being parallel to a second axis, wherein multiple sensing points are formed in a touch area by the first electrodes and the second electrodes; a first bus laid outside the touch area including multiple first circuits respectively coupled to the first electrodes and a touch sensitive processing apparatus; a second bus laid outside the touch area including multiple second circuits respectively coupled to the second electrodes and the touch sensitive processing apparatus; and a dummy electrode set laid outside the touch area including one or more dummy electrodes, wherein a separate area is formed between a part of the first bus and a part of the second bus, the dummy electrode set is laid inside the separate area, and the total area of the dummy electrode set is less than the area of the separate area.

### CROSS REFERENCE TO RELATED APPLICATIONS

This application claims priority to U.S. patent application 62/512,206, filed on May 30, 2017, the disclosure of which is incorporated herein by reference.

### BACKGROUND OF THE INVENTION

### 1. Field of the Invention

The present invention relates to the field of touch panel, and more particularly, to a touch panel which can decrease the phenomenon of electromagnetic interference (EMI) caused by dummy electrodes between circuits of buses.

### 2. Description of the Prior Art

Touch panels or screens are main input/output devices of modern electronic systems. Since capacitive touch panels have a good detection characteristic, they gradually become one of the mainstream product designs of touch panels.

As shown in FIG. 1, a typical capacitive touch panel 100 usually includes a touch area 110. The touch area 110 includes multiple first electrodes 111 being parallel to a first axis (or a horizontal axis) and multiple second electrodes 112 being parallel to a second axis (or a vertical axis). These electrodes 111 and 112 have to connect to a touch sensitive processing apparatus to realize touch sensitive functions. Therefore, outside the touch area 110, there are at least two sets of lines (or two buses) inside a glass panel or an area of flexible printed circuit board (FPCB).

A first bus 121 includes circuits connecting to each first electrode 111. A second bus 122 includes circuits connecting to each second electrode 112. The two buses 121 and 122 may be circuits on the panel 100, such as transparent circuits of indium tin oxide (ITO), or circuits consisting of metal(s), such as copper, silver, gold, etc., or alloy. The present invention does not limit the material of the two buses 121 and 122. The present invention does not require that the two buses 121 and 122 are on the same layer. In other words, in some cases, the two buses 121 and 122 may not limit to neither the circuits formed by transparent material nor on the same layer of a substrate. They may be a three-dimensional multi-layer structure.

The two buses 121 and 122 may connect to the abovementioned touch sensitive processing apparatus through a narrow interface at the edge of the touch panel 100. Therefore, it is highly probable to form a wiring layout with parallel buses 121 and 122 in real implementations.

As shown in FIG. 1, the two buses 121 and 122 are parallel to each other in three directions. Dummy electrodes 130 may exist between the two buses 121 and 122. When the touch panel 100 is in operation, the voltages of the dummy electrodes 130 are floating. The touch sensitive processing apparatus does not connect to the dummy electrodes 130 thus it cannot control the voltages of the dummy electrodes 130. As the same as the mentioned two buses 121 and 122, the dummy electrodes 130 may not limit to neither the circuits formed by transparent material nor on the same layer of a substrate with the buses 121 and/or 122.

Referring to FIG. 2, it shows a drawing of partial enlargement for the dotted area of FIG. 1. The dummy electrode 130 is arranged in the middle of FIG. 2. The second bus 122 is above it and the first bus 121 is below it. The dummy electrode 130 and circuits of the two buses 121 and 122 form capacitors. For example, the dummy electrode 130 and the bottom circuit of the second bus 122 form a capacitor C21. Also, the dummy electrode 130 and the bottom circuit of the second bus 122 form a capacitor C11.

Since voltage of the dummy electrode 130 is floating, it is affected by the circuits above and below the dummy electrode 130. For example, when a driving signal is provided to the circuits of the first bus 121, the dummy electrode 130 is affected by the capacitor C11 so that the voltage of the dummy electrode 130 is changed. Further, because of the effect of the capacitor C21, the circuits of the second bus 122 are affected by the dummy electrode 130 so that the electrical characteristic(s) of the circuits of the second bus 122 is/are changed. In other words, the dummy electrode 130 between the buses 121 and 122 causes electromagnetic interference (EMI) between the two buses 121 and 122. Therefore, the present invention intends to solve one of the problems, that is, to reduce the EMI between the buses outside of the touch area of the touch panel.

### SUMMARY OF THE INVENTION

In an embodiment of the present invention, it provides a touch panel including: multiple first electrodes being parallel to a first axis; multiple second electrodes being parallel to a second axis, wherein multiple sensing points are formed in a touch area by the multiple first electrodes and the multiple second electrodes; a first bus laid outside the touch area including multiple first circuits respectively coupled to the first electrodes and a touch sensitive processing apparatus; a second bus laid outside the touch area including multiple second circuits respectively coupled to the second electrodes and the touch sensitive processing apparatus; and a dummy electrode set laid outside the touch area including one or more dummy electrodes, wherein a separate area is formed between a part of the first bus and a part of the second bus, the dummy electrode set is laid inside the separate area, and the total area of the dummy electrode set is less than the area of the separate area.

The technical means of the present invention is to remove the dummy electrode or reduce the total area of the dummy electrode between the buses so that the mutual capacitance between the buses and the dummy electrode can be eliminated or decreased. Also, the EMI caused by the dummy electrode between circuits of the buses can be decreased.

### BRIEF DESCRIPTION OF THE DRAWINGS

The present invention can be more fully understood by reading the following detailed description of the preferred embodiments, with reference made to the accompanying drawings, wherein:

FIG. 1 shows a schematic diagram of a bus layout for a touch panel in the prior art;

FIG. 2 shows a drawing of partial enlargement of FIG. 1;

FIG. 3 shows a bus layout of a touch panel according to an embodiment of the present invention;

FIGS. 4A-C show bus layouts of touch panels according to embodiments of the present invention; and

FIG. 5 shows a bus layout of a touch panel according to an embodiment of the present invention.

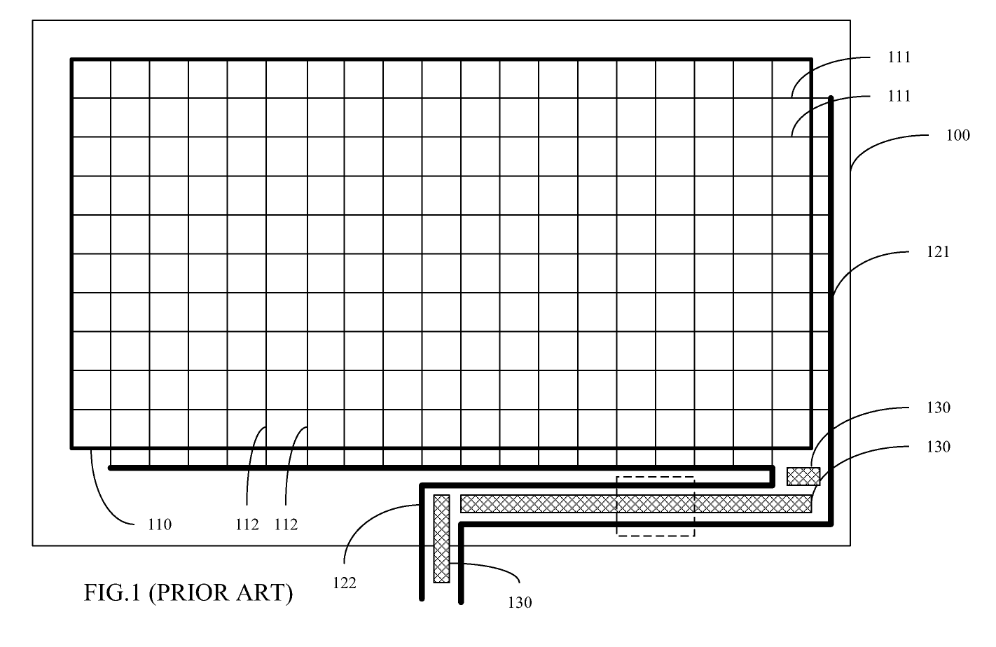

### DETAILED DESCRIPTION OF THE PREFERRED EMBODIMENTS

Some embodiments of the present invention are described in detail below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

If any terms in this application conflict with terms used in any application(s) from which this application claims priority, or terms incorporated by reference into this application or the application(s) from which this application claims priority, a construction based on the terms as used or defined in this application should be applied.

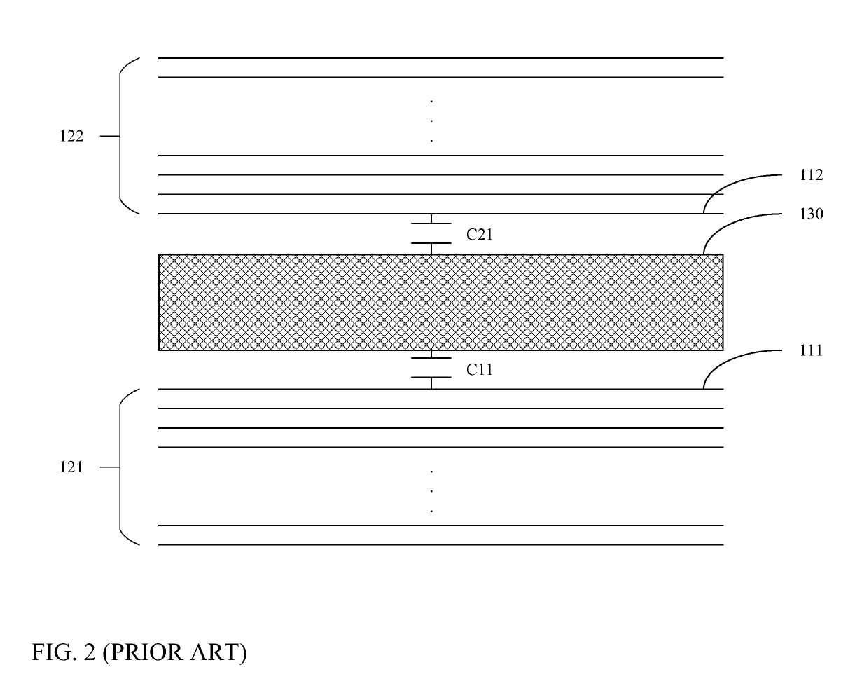

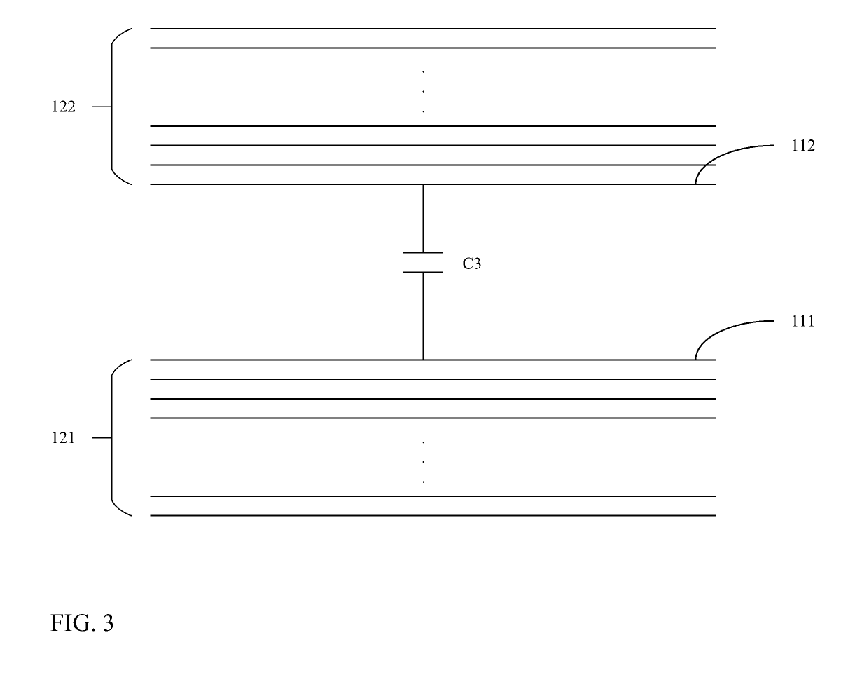

Referring to FIG. 3, it shows a circuit layout according to one embodiment of the present invention. Compared to the circuit layout shown in FIG. 2, the circuit layout shown in FIG. 3 still includes the first bus 121 and the second bus 122. In some embodiments, a capacitor C3 is formed between two nearest circuits of the two buses 121 and 122. Since the distance between the two circuits of the capacitor C3 is larger than that of the capacitors C11 and C21 and the areas of the two circuits are smaller than that of the dummy electrode 130, capacitance of the capacitor C3 is smaller than capacitances of the capacitors C11 and C21. In other words, by removing the dummy electrode 130 of FIG. 2, the EMI between the first bus 121 and the second bus 122 decreases.

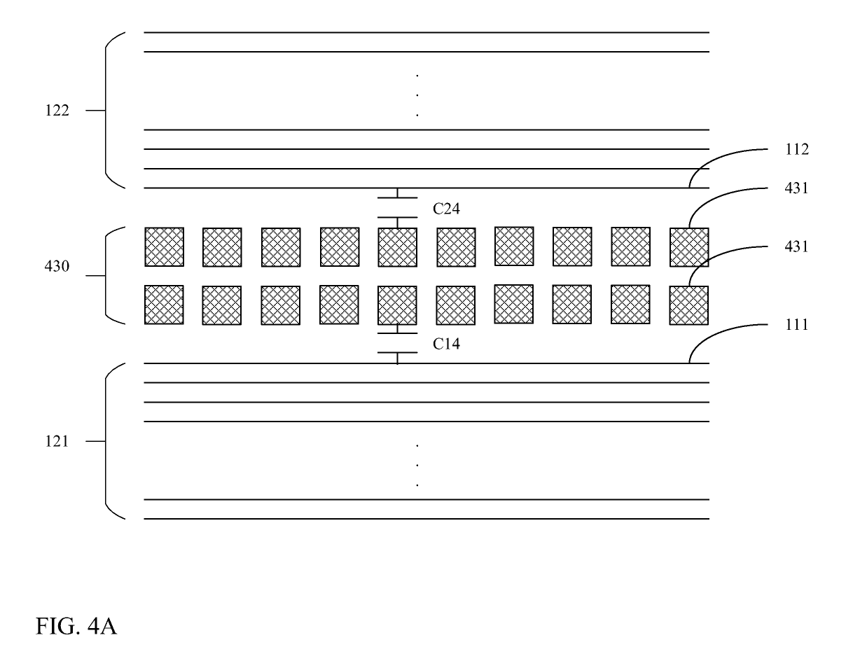

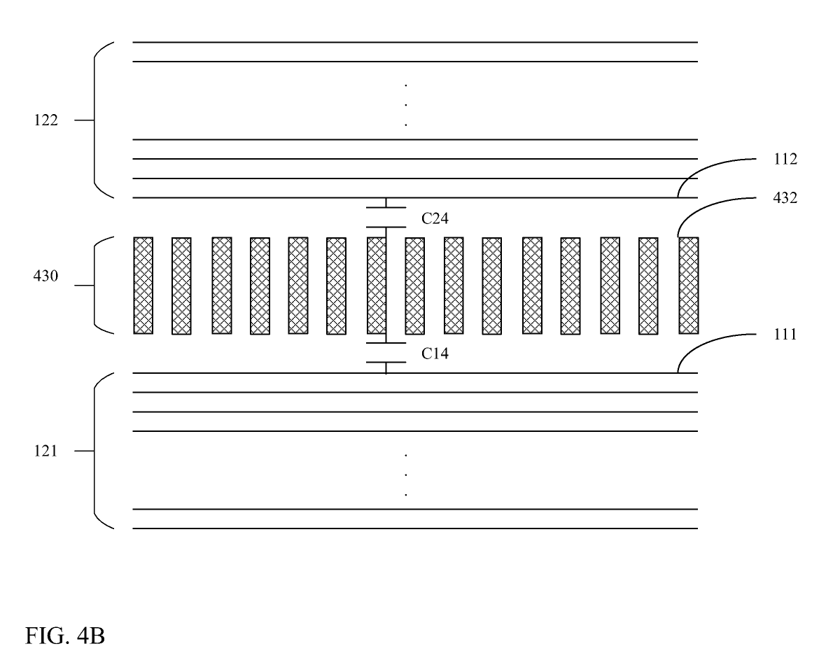

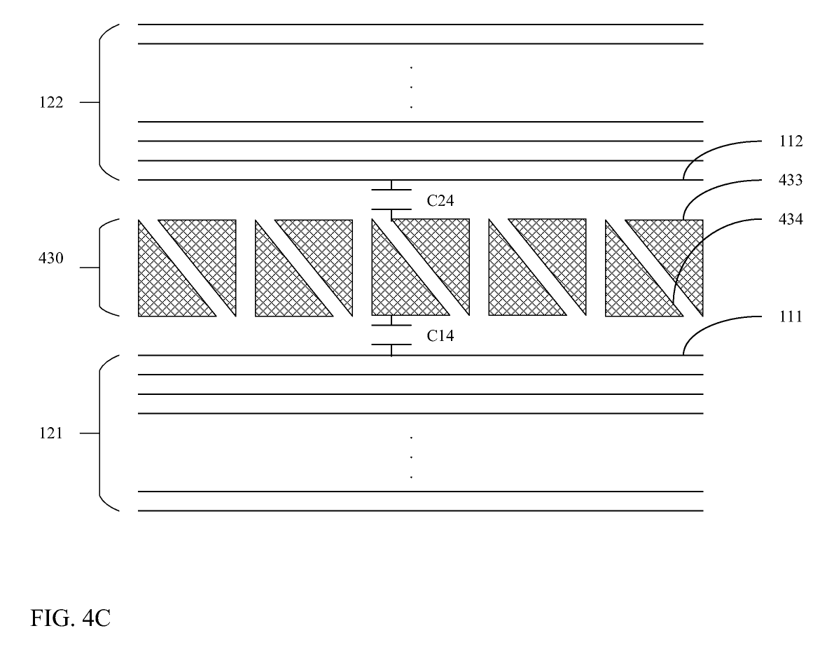

Referring to FIG. 4A, it shows a circuit layout according to one embodiment of the present invention. Compared to the circuit layout shown in FIG. 2, the circuit layout shown in FIG. 4A still includes the first bus 121 and the second bus 122. Compared to the dummy electrode 130 shown in FIG. 2, a dummy electrode set 430 shown in FIG. 4 consists of multiple dummy electrodes 431. Although the dummy electrodes 431 shown in FIG. 4A are square, the present invention does not limit to the shapes, areas, and quantities of the dummy electrodes 431. The total area of the dummy electrode set 430 shown in FIG. 4A is smaller compared to that of the dummy electrode 130 shown in FIG. 2.

The dummy electrode set 430 and the bottom circuit of the second bus 122 form a capacitor C24. Also, the dummy electrode set 430 and the top circuit of the first bus 121 form a capacitor C14. Since the total area of the dummy electrode set 430 is smaller than that of the dummy electrode 130, capacitance of the capacitor C24 is smaller than capacitance of the capacitor C21 and capacitance of the capacitor C14 is smaller than capacitance of the capacitor C11. The area of dummy electrode set 430 needs to be smaller than that of the dummy electrode 130 shown in FIG. 2, the EMI between the first bus 121 and the second bus 122 decreases.

Referring to FIG. 4B, it shows a circuit layout according to one embodiment of the present invention. The difference between FIGS. 4A and 4B is that the dummy electrodes 432 shown in FIG. 4B are rectangle. Compared to the area of the dummy electrode 130 shown in FIG. 2, the total area of the dummy electrode set 430 shown in FIG. 4B is smaller, the EMI between the first bus 121 and the second bus 122 decreases.

Referring to FIG. 4C, it shows a circuit layout according to one embodiment of the present invention. The difference between FIGS. 4A and 4C is that two shapes of dummy electrodes 433 and 434 are shown in FIG. 4C. Compared to the area of the dummy electrode 130 shown in FIG. 2, the total area of the dummy electrode set 430 shown in FIG. 4C is smaller, the EMI between the first bus 121 and the second bus 122 decreases.

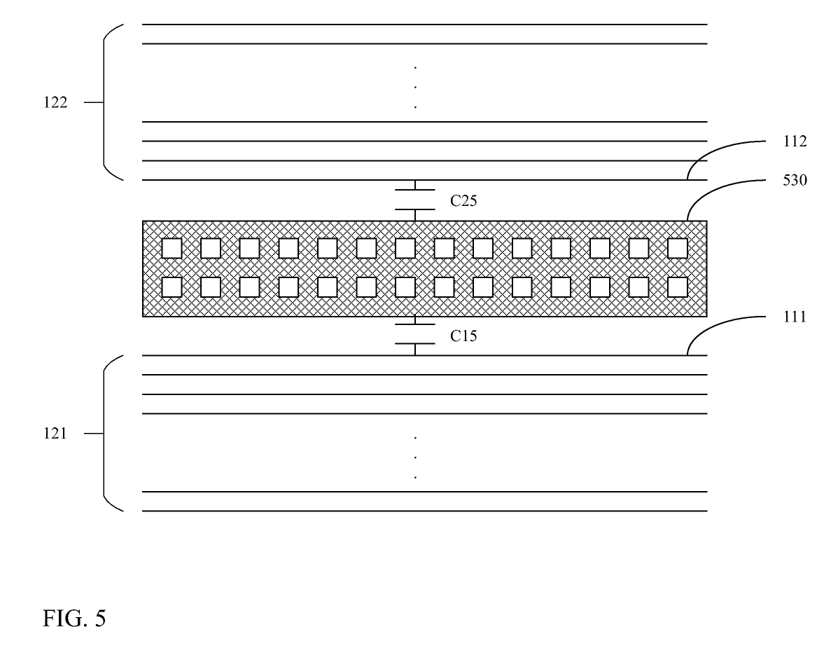

Referring to FIG. 5, it shows a circuit layout according to one embodiment of the present invention. Compared to the circuit layout shown in FIG. 2, the circuit layout shown in FIG. 5 still includes the first bus 121 and the second bus 122. Compared to the dummy electrode 130 shown in FIG. 2, a lot of spaces within the dummy electrode 530 shown in FIG. 5 are not conductive. Although the spaces within the dummy electrode 530 shown in FIG. 5 are square, the present invention does not limit to the shapes, areas, and quantities of the spaces in the dummy electrode 530. The area of the dummy electrode 530 shown in FIG. 5 is smaller compared to that of the dummy electrode 130 shown in FIG. 2.

The dummy electrode 530 and the bottom circuit of the second bus 122 form a capacitor C25. Also, the dummy electrode 530 and the top circuit of the first bus 121 form a capacitor C15. Since the area of the dummy electrode 530 is smaller than that of the dummy electrode 130, capacitance of the capacitor C25 is smaller than capacitance of the capacitor C21 and capacitance of the capacitor C15 is smaller than capacitance of the capacitor C11. Therefore, by shrinking area of the dummy electrode 130 of FIG. 2, the EMI between the first bus 121 and the second bus 122 decreases.

It is worth noting that the buses 121 and 122 are parallel in the embodiments of FIGS. 3-5 but the present invention does not limit to the buses 121 and 122 having to be parallel. They may show a circuit layout in getting closer. Besides, the dummy electrode set 430 may be designed to a set including multiple dummy electrodes 530 having inner spaces. Similarly, the dummy electrodes, even in the same set, may not have the same shape or size.

The technical means of the present invention is to remove the dummy electrode or reduce the total area of the dummy electrode between the buses so that the mutual capacitance between the buses and the dummy electrode can be eliminated or decreased. Also, the EMI caused by the dummy electrode between circuits of the buses can be decreased.

In an embodiment of the present invention, it provides a touch panel including: multiple first electrodes being parallel to a first axis; multiple second electrodes being parallel to a second axis, wherein multiple sensing points are formed in a touch area by the multiple first electrodes and the multiple second electrodes; a first bus laid outside the touch area including multiple first circuits respectively coupled to the first electrodes and a touch sensitive processing apparatus; a second bus laid outside the touch area including multiple second circuits respectively coupled to the second electrodes and the touch sensitive processing apparatus; and a dummy electrode set laid outside the touch area including one or more dummy electrodes, wherein a separate area is formed between a part of the first bus and a part of the second bus, the dummy electrode set is laid inside the separate area, and the total area of the dummy electrode set is less than the area of the separate area.

In an embodiment, for convenience of layout design and implementation, the separate area is a rectangle. In one example, the part of the first bus and the part of the second bus are parallel to the first axis or the second axis.

In an embodiment, for convenience of layout design and implementation, the part of the first bus is on a first side of the touch panel and the part of the second bus is on a second side of the touch panel. The first side is back to the second side. At least one of the dummy electrodes is on the first side, at least one of the dummy electrodes is on the second side.

In an embodiment, for convenience of layout design and implementation, the dummy electrodes are the same in shape and size. In one example, at least two of the dummy electrodes are different in shape or size.

In an embodiment, for reducing the EMI caused by the dummy electrode between circuits of the buses, space within one of the dummy electrode includes multiple non-conductive areas. In one example, for convenience of layout design and implementation, the non-conductive areas are the same in shape and size. In one example, at least two of the non-conductive areas are different in shape or size.

In an embodiment, the touch panel is a part of a touch screen.

In an embodiment, for reducing the EMI caused by the dummy electrode between circuits of the buses, a total area of the dummy circuit set is less than 80% of the area of the separate area. In one example, a total area of the dummy circuit set is less than 50% of the area of the separate area.

In an embodiment, the separate area can be an area defined by the top first circuit 111 of the first bus 121 and the bottom second circuit 112 of the second bus 122, such as those shown in FIGS. 4A-4C and FIG. 5. When the first bus 121 and the second bus 122 are parallel, the separate area can be the area between both of them with the first bus 121 and the second bus 122 being parallel.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A touch panel, comprising:
a plurality of first electrodes, being parallel to a first axis;
a plurality of second electrodes, being parallel to a second axis, wherein a plurality of sensing points are formed in a touch area by the first electrodes and the second electrodes;
a first bus laid outside the touch area, comprising a plurality of first circuits respectively coupled to the first electrodes and a touch sensitive processing apparatus;
a second bus laid outside the touch area, comprising a plurality of second circuits respectively coupled to the second electrodes and the touch sensitive processing apparatus; and
a dummy electrode set, laid outside the touch area and comprising one or more dummy electrodes,
wherein a separate area is formed between a part of the first bus and a part of the second bus, the dummy electrode set is laid inside the separate area, and the total area of the dummy electrode set is less than the area of the separate area.

2. The touch panel of claim 1, wherein the part of the first bus is on a first side of the touch panel, the part of the second bus is on a second side of the touch panel, the first side is back to the second side, at least one of the dummy electrodes is on the first side, at least one of the dummy electrodes is on the second side.

3. The touch panel of claim 1, wherein the dummy electrodes are the same in shape and size.

4. The touch panel of claim 1, wherein at least two of the dummy electrodes are different in shape or size.

5. The touch panel of claim 1, wherein a space within one of the dummy electrodes includes a plurality of non-conductive areas.

6. The touch panel of claim 5, wherein the non-conductive areas are the same in shape and size.

7. The touch panel of claim 5, wherein at least two of the non-conductive areas are different in shape or size.

8. The touch panel of claim 1, wherein a total area of the dummy circuit set is less than 80% of the area of the separate area.

9. The touch panel of claim 1, wherein the separate area is a rectangle.

10. The touch panel of claim 9, wherein the part of the first bus and the part of the second bus are parallel to the first axis or the second axis.
